(19) United States
(12) Patent Application Publication
(10) Pub. No.: US 2023/0381898 A1
(43) Pub. Date: Nov. 30, 2023

(54) WELDING DEVICE WITH NOZZLE APPARATUS FOR COOLING A WORKPIECE DURING THE WELDING PROCESS

(71) Applicant: Linde GmbH, Pullach (DE)

(72) Inventor: Erwan SIEWERT, Pullach (DE)

(21) Appl. No.: 18/248,171

(22) PCT Filed: Oct. 6, 2021
(86) PCT No.: PCT/EP2021/025392

§ 371 Date: Apr. 6, 2023

(30) Foreign Application Priority Data
Oct. 13, 2020 (EP) 20020471.7

(51) Int. Cl. B23K 37/00; B23K 9/23; B23K 9/16

(52) U.S. Cl. CPC B23K 37/003; B23K 9/23; B23K 9/164

(57) ABSTRACT

The invention relates to a welding device for welding at least one workpiece, comprising: a welding torch, which is designed to create an electric arc for welding the at least one workpiece; and a nozzle apparatus, which is arranged on the welding torch and has a cooling nozzle array, which has at least one row of cooling nozzles, wherein for cooling the workpiece, the respective cooling nozzle can be supplied with an adjustable volume flow of a cooling medium.

The invention relates to a welding device, in particular for an arc welding process, e.g., in the form of WAAM (wire arc additive manufacturing).

When using electric arc technology for joining, build-up welding and generative joining (also called wire arc additive manufacturing), heat is introduced into the component or the structure by completely or partially melting the base material and filler material. In particular, if a plurality of layers of filler material is introduced, an accumulation of the heat input occurs.

In the case of WAAM (wire arc additive manufacturing), a metallic material is applied in layers with established MIG methods so that a 3D structure or a corresponding workpiece is produced. It is problematic that the workpiece heats up over the welding time so that the electrical conditions, the thermal conditions and the layer structure are changed and deformations as well as discolorations occur.

In addition, an uncontrolled change in the mechanically technological material properties occurs since the previous layers are thermally influenced by each further layer.

An attempt is currently being made to bring the problems described above under control through breaks in which the workpiece cools. The high melting power of the MIG methods is relativized by the necessity of these cooling breaks.

It is in principle possible to cool WAAM structures with gas flows so that metallurgical properties can be improved and no or fewer cooling breaks have to be taken. However, such solutions only work in the case of very simple structures, such as in the construction of a tube (circular path), and in this case also only if the structure to be constructed rotates about its own axis and it is not the welding torch that is being moved. In this case, the cooling nozzles can always be positioned at a constant distance from the welding torch. The cooling position does not have to be changed.

As soon as the tube no longer rotates about its own axis (turntable), the burner moves or else more complex geometries are welded, the position to be cooled is constantly changed.

Based thereon, the object of the present invention is to provide a welding apparatus that is improved with regard to the aforementioned problems.

This object is achieved by a welding device having the features of claim 1. Advantageous embodiments of the invention are specified in the corresponding dependent claims and are described below.

According to claim 1, a welding device for welding at least one workpiece is disclosed, comprising:
a welding torch, which is designed to create an electric arc for welding the at least one workpiece; and
a nozzle apparatus, which is arranged on the welding torch and has a cooling nozzle array, which has at least one row of cooling nozzles, wherein, for cooling the workpiece (in particular during a welding process), the respective cooling nozzle can be supplied with a predefinable volume flow of a cooling medium and is designed to eject the cooling medium onto a surface of the workpiece to be cooled.

The invention thus advantageously allows cooling of the workpiece in the vicinity of the energy input in order to counteract overheating, even if the movement direction and/or orientation of the welding torch changes during welding, since a plurality of cooling nozzles is available which can be supplied with a cooling medium.

According to one embodiment of the invention, it is provided that the at least one row of the cooling nozzle array extends linearly or in a curve, in particular annularly.

In particular, the cooling nozzles of the nozzle apparatus can be arranged next to one another in a circumferential direction of the welding torch, preferably equidistantly, so that the cooling nozzle array extends annularly around the welding torch.

This is particularly advantageous in applications in which good accessibility is necessary. Due to the annular arrangement, the cooling nozzles can be arranged around the welding torch in the smallest possible installation space.

Furthermore, it is provided according to one embodiment of the invention that the cooling nozzle array has a plurality of rows of cooling nozzles, wherein the cooling nozzle array in particular has at least one radial row to the center point, preferably a plurality of radial rows, of cooling nozzles and at least two nozzles are arranged in the row, wherein the nozzles are arranged at different radial distances to the center point, wherein the cooling nozzle array in particular represents a two-dimensional field or array of cooling nozzles, wherein the individual rows can in particular extend linearly or in a curve, in particular annularly. In particular in the event that a plurality of rows of cooling nozzles is used or present, individual cooling nozzles can also be directed inward, onto the still hot weld seam or structure.

Furthermore, it is provided according to one embodiment of the invention that a plurality of cooling nozzles (in particular a selected row, a plurality of selected rows or all rows) of the cooling nozzle array can be supplied with an adjustable volume flow of a particular cooling medium.

According to a further embodiment of the invention, it is provided that at least one cooling nozzle of the nozzle apparatus can be supplied with a first cooling medium and at least one further cooling nozzle of the nozzle apparatus can be supplied with a second cooling medium, wherein the second cooling medium differs from the first cooling medium in its composition.

The cooling medium for the individual cooling nozzles can thus be changed, or different cooling nozzles can be supplied with different cooling media. For example, it is possible to supply a cooling medium, in particular a gas, in particular an inert gas, to the cooling nozzles that are close to the electric arc, wherein the cooling nozzles that are further removed from the electric arc can be supplied with an active gas or with a gas with increased active fractions or else with a liquid, such as water. As a result, the cooling effect is greatly increased without the electric arc being influenced by the water, for example.

According to a particularly preferred embodiment of the invention, it is provided that the cooling nozzle array can be rotated about a rotational axis, so that the cooling nozzles can in particular be moved around the welding torch so that a coolant flow dispensed by one or more cooling nozzles can preferably be directed onto a still hot surface of the at least one workpiece, even if the welding torch has already changed its orientation and/or movement direction during welding. Here, a rotational axis of this rotation can coincide with a longitudinal axis of the welding torch but can also have an inclination relative to this longitudinal axis (e.g., if the cooling nozzle array can be tilted about a further tilting axis, see below).

Furthermore, it is provided according to one embodiment of the invention that for rotating the cooling nozzle array about the rotational axis, the welding device has at least one electric motor or a pneumatic drive (or similar movement units).

According to a further embodiment of the invention, it is provided that the welding device is designed to adjust a rotation angle of the cooling nozzle array with respect to the rotational axis on the basis of a temperature signal and/or on the basis of an automatic calculation based on a known or planned movement sequence of the welding torch during the welding process.

Furthermore, it is provided according to one embodiment of the invention that the cooling nozzle array can be tilted about a tilting axis, in particular about a horizontal tilting axis. This makes it easier to always direct the cooling medium flow onto the optimal cooling position (generally behind the welding process or behind the current weld pool in the movement direction of the welding torch so that the cooling or cooling position follows the welding torch).

Furthermore, it is provided according to one embodiment of the invention that the welding device has temperature sensors (particularly advantageously optical sensors) which are configured to detect a temperature distribution of the workpiece produced by means of the welding device.

According to a further embodiment of the invention, it is provided that the welding device is designed to control or adjust, on the basis of the detected temperature distribution or temperature information, a volume flow of a cooling medium dispensed through the respective cooling nozzle, so that the temperature distribution in particular can be approximated to a desired temperature distribution. Furthermore, a point of action of the cooling on the surface of the at least one workpiece can be controlled in this way on the basis of the temperature information.

For controlling the volume flows, the nozzle apparatus may, for example, have valves which are provided upstream of the cooling nozzles and which can be actuated or operated pneumatically or electrically, for example. The valves may be proportional valves, for example. Instead of valves, displaceable diaphragms may also be used.

Furthermore, the known path contours can be used to calculate (e.g., by means of a simulation) at which locations of the workpiece an accumulation of heat will occur. Accordingly, it is possible to specifically cool these locations more strongly than locations at which no heat accumulation is calculated.

The cooling strategy is preferably carried out on the basis of a distortion calculation. The respective flow or volume flow of a cooling medium through the respective cooling nozzle is preferably variably adjustable, e.g., by the use of proportional valves.

For intensifying the cooling, the welding device or the nozzle apparatus is designed to open a plurality of cooling nozzles simultaneously or to dispense a cooling medium via a plurality of cooling nozzles simultaneously.

The individual cooling nozzles can be mounted on the nozzle apparatus, for example, via a thread, so that they can be easily exchanged.

Furthermore, the individual cooling nozzles can have different flow characteristics and can thus be adapted to the respective application. In particular, the respective cooling nozzle can, for example, generate a rotationally symmetrical flow field or else a non-rotationally symmetric flow field. For this purpose, the corresponding cooling nozzle can be designed as a slotted nozzle, for example.

Furthermore, it is provided according to one embodiment of the invention that the welding device be designed to supply a cooling nozzle that is closer to the electric arc than a further cooling nozzle with a lower volume flow of a cooling medium than the further cooling nozzle in order to reduce the risk of interaction of the cooling medium with a process gas (e.g., protective gas) of the welding process. The process gas may, for example, be a protective gas and/or a focusing gas which the welding torch dispenses in order to protect the welding point against oxidation or to control the electric arc.

Furthermore, it is provided according to one embodiment of the invention that the welding device is designed to dispense, as cooling medium, one or more of the following media via at least one cooling nozzle: argon, helium, nitrogen, hydrogen, air, carbon dioxide, a mixture of a selection of the aforementioned gases. For each cooling medium used, the welding apparatus can have a container which is fluidically connected or connectable to the nozzle apparatus (e.g., via the aforementioned valves).

A further aspect of the present invention relates to a method for welding at least one workpiece, wherein the workpiece is constructed in layers by means of a welding device according to the invention and is cooled by means of the nozzle apparatus.

The present invention can be particularly effectively used in additive manufacturing (e.g., WAAM) since a strong heat input into the workpiece occurs in this case.

However, the solution according to the invention can also be used for conventional welding processes or for build-up welding.

The principle according to the invention can be used particularly advantageously in applications in which the welding direction changes more often or constantly or in applications in which increased distortion occurs. The invention can be used in methods which supply the filler material by wire as well as by a powder.

The invention is in principle suitable for all welding processes (in particular for MIG, TIG, plasma welding, laser welding, special methods, such as hybrid methods, tandem, etc.)

The invention advantageously allows the preservation of the mechanically technological material properties. At the same time, an increase in the production speeds is achieved since no cooling phases are necessary between the individual layers (often more than 50%).

Furthermore, the invention enables a reduction of the thermal distortion to a minimum. The layer structure is predictable and less unevenness of the 3D structure to be produced can be achieved (so-called near net shape is improved). Furthermore, the invention enables a reduction in discolorations.

Embodiments, further features and advantages of the present invention are explained below with reference to the figures. The figures show:

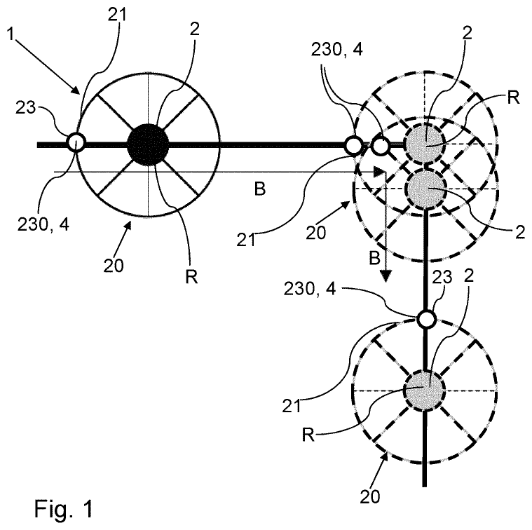

FIG. 1 a schematic representation of an embodiment of a welding device according to the invention in plan view during a welding process, wherein the welding torch changes direction by 90°,

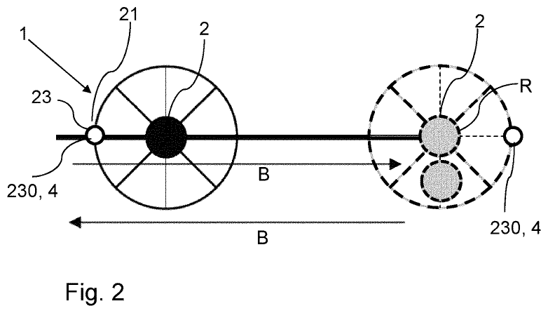

FIG. 2 a schematic representation of an embodiment of a welding device according to the invention in plan view during a welding process, wherein the welding torch changes direction by 180°,

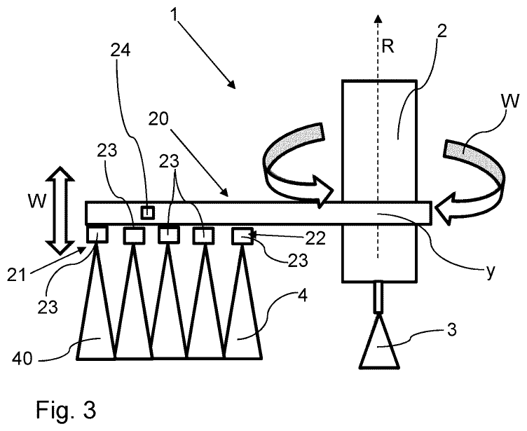

FIG. 3 a schematic side view of an embodiment of a welding device according to the invention with a cooling nozzle array which is rotatably mounted on the welding torch,

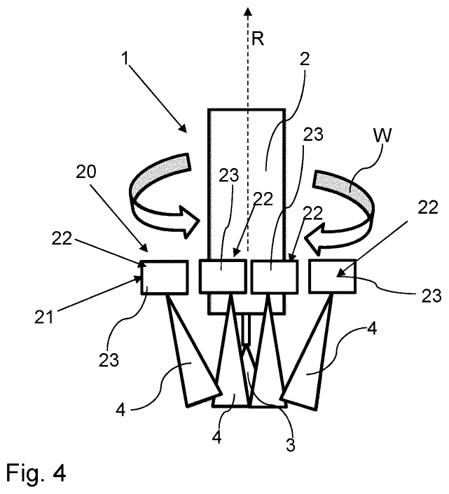

FIG. 4 a further schematic side view of the welding device shown in FIG. 3, and

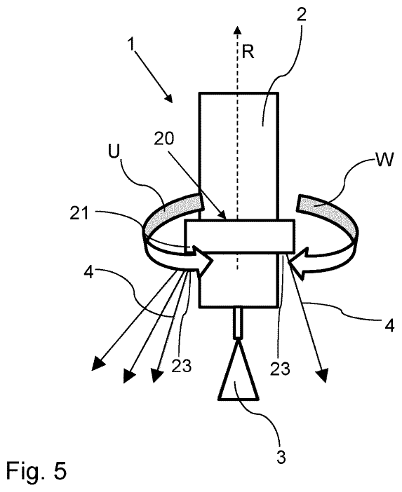

FIG. 5 a schematic side view of a further embodiment of a welding device according to the invention.

FIGS. 1 and 2 show a schematic plan view of an embodiment of a welding device 1 according to the invention during a welding process, wherein the welding torch 2 changes direction by 90° (cf. FIG. 1) or 180° C. (cf. FIG. 2).

For performing the welding process, the welding device 1 according to FIGS. 1 and 2 has a welding torch 2 which is designed to create an electric arc so that, for example, a filler material or a surface of a workpiece to be manufactured can be melted in order, for example, to construct the workpiece layer by layer within the scope of a WAAM method.

In order to be able to cool the workpiece in a targeted manner during the welding process, the welding device 1 has a nozzle apparatus 20 which is arranged on the welding torch 2 and has a cooling nozzle array 21, which has at least one row 22 of cooling nozzles 23, wherein for cooling the workpiece, the respective cooling nozzle 23 can be supplied with an adjustable volume flow of a cooling medium 4.

The cooling nozzle array 21 according to FIGS. 1 and 2 can preferably be rotated about a rotational axis R so that the cooling nozzles 23 can in particular be moved around the welding torch 2. In FIGS. 1 and 2, the rotational axis is perpendicular to the plane of the sheet.

Thus, for example, when the welding torch 2 changes direction by 90°, as is shown in FIG. 1, the cooling position 230, i.e., the surface region 230 of the workpiece that is subjected to a cooling medium 4, can be adapted to the change in direction by rotating the cooling nozzle array about the rotational axis R, ideally such that in the movement direction B of the welding torch 2, the cooling position is behind the current weld pool which is created by means of the electric arc of the welding torch. FIG. 2 shows the adjustment of the cooling position 230 when the welding torch 2 changes direction by 180°.

The welding device 1 shown in FIGS. 1 and 2 can be embodied, for example, according to FIG. 3. In this case, the cooling nozzle array 21 has at least one row 22 of cooling nozzles 23, wherein the cooling nozzles 23 have different distances to the electric arc 3 of the welding torch. The cooling nozzle array 21 can be pivoted about a rotational axis R, wherein the rotation angle W can be adjusted by means of a suitable actuator which causes the rotation of the cooling nozzle array 21. In addition, the cooling nozzle array can be tilted or pivoted about a tilting axis y, in this case, for example, a horizontal tilting axis y. A particular cooling medium 4, with a variable volume flow in each case, can be dispensed through the individual cooling nozzles 23. Different cooling media 4, 40 can also be dispensed via the cooling nozzles 23. Furthermore, the rotation angle W of the cooling nozzle array 21 with respect to the rotational axis R and/or a tilting angle W′ with respect to the tilting axis y can be adjusted on the basis of a temperature signal, which may be provided, for example, by a temperature sensor 24. Furthermore, the temperature signal can be used to adjust the volume flows of the cooling medium/media 4, 40.

The cooling medium or media can each be one of the following cooling media: argon, helium, nitrogen, hydrogen, air, carbon dioxide, a mixture of a selection of the aforementioned gases.

As is furthermore shown in FIG. 4, the cooling nozzle array 21 of the welding device 1 according to FIG. 3 can have a plurality of rows 22 of cooling nozzles 23, wherein, for example, it is possible to orient the coolant flows 4 of the cooling nozzles of the outermost rows 22 inward in order to concentrate the cooling power onto the path traveled by the welding torch 2.

FIG. 5 shows a further embodiment of a welding device 1 according to the invention, wherein, in contrast to FIGS. 3 and 4, the cooling nozzles 23 are in this case arranged annularly around the welding torch 2 in a circumferential direction U of the welding torch 2, preferably equidistantly to one another, so that the cooling nozzle array 21 extends annularly around the welding torch 2.

1. Welding device for welding at least one workpiece, comprising:
a welding torch, which is designed to create an electric arc for welding the at least one workpiece;
a nozzle apparatus, which is arranged on the welding torch and has a cooling nozzle array, wherein the cooling nozzle array has at least one radial row of cooling nozzles and at least two cooling nozzles are arranged in the row, wherein for cooling the workpiece, the respective cooling nozzle can be supplied with an adjustable volume flow of a cooling medium.

2. Welding device according to claim 1, wherein the cooling nozzles of the nozzle apparatus are arranged next to one another in a circumferential direction (U) of the welding torch, preferably equidistantly, so that the cooling nozzle array extends annularly around the welding torch.

3. Welding device according to claim 1, wherein the cooling nozzle array has a plurality of rows of cooling nozzles.

4. Welding device according to claim 1, wherein a plurality of cooling nozzles of the cooling nozzle array can be supplied with an adjustable volume flow of a particular cooling medium.

5. Welding device according to claim 1, wherein at least one cooling nozzle can be supplied with a first cooling medium and at least one further cooling nozzle can be supplied with a second cooling medium, wherein the second cooling medium differs from the first cooling medium in its composition.

6. Welding device according to claim 1, wherein the cooling nozzle array can be rotated about a rotational axis (R) so that the cooling nozzles can in particular be moved around the welding torch.

7. Welding device according to claim 6, wherein the welding device (1) is designed to adjust a rotation angle (W) of the cooling nozzle array with respect to the rotational axis (R) on the basis of a temperature signal and/or on the basis of an automatic calculation based on a known movement sequence of the welding torch during the welding process.

8. Welding device according to claim 1, wherein the cooling nozzle array can be tilted about a tilting axis (y), in particular a horizontal tilting axis.

9. Welding device according to claim 1, wherein the welding device has at least one temperature sensor that is configured to detect a temperature distribution of a workpiece produced by means of the welding device.

10. Welding device according to claim 9, wherein the welding device is designed to control, on the basis of the detected temperature distribution, a volume flow of a cooling medium dispensed through the respective cooling nozzle.

11. Welding device according to claim 1, wherein the respective cooling nozzle is fixed to the nozzle apparatus via a thread.

12. Welding device according to claim 1, wherein the welding device is designed to supply a cooling nozzle of the cooling nozzle array that is closer to the electric arc than a further cooling nozzle with a lower volume flow of a cooling medium than the further cooling nozzle in order to reduce the risk of interaction of the cooling medium with a process gas of the welding process.

13. Welding device according to claim 1, wherein the welding device is designed to dispense as cooling medium one of the following medium via at least one cooling nozzle: argon, helium, nitrogen, hydrogen, air, carbon dioxide, a mixture of a selection of the aforementioned gases.

14. A method for welding at least one workpiece, wherein the workpiece is constructed in layers by means of a welding device according to claim 1 and is cooled by means of the nozzle apparatus.
